(19) United States
(12) Patent Application Publication
(10) Pub. No.: US 2002/0127529 A1
(43) Pub. Date: Sep. 12, 2002

(54) Prediction model creation, evaluation, and training

(76) Inventors: Nadav Yehudah Cassuto, St. Louis Park, MN (US); Deborah Ann Campbell, Chanhassen, MN (US); Randy Lee Erdahl, Chaska, MN (US)

Correspondence Address: MERCHANT & GOULD PC, P.O. BOX 2903, MINNEAPOLIS, MN, 55402-0903, US

(21) Appl. No.: 09/731,188

(22) Filed: Dec. 6, 2000

(51) Int. Cl. G09B 7/00

(52) U.S. Cl. 434/335

(57) ABSTRACT

Methods and apparatuses are disclosed that create prediction models. Embodiments of the methods involve various elements such as sampling representative data, detecting statistical faults in the data, inferring missing values in the data set, and eliminating independent variables. Methods and apparatuses are also disclosed that train analysts to create prediction models. Embodiments of these methods involve providing operational component selections to the user, receiving operational and configuration selections, and displaying the result of applying the operational components and selections to representative data.

### TECHNICAL FIELD

The present invention is related to prediction models. More specifically, the present invention is related to aspects of computer-implemented prediction models.

### BACKGROUND

Prediction models are used in industry to predict various occurrences. Prediction models are based on past behavior to determine future behavior. For example, a company may sell products through a catalog and may wish to determine the customers to target with a catalog to ensure that the catalog will result in a sufficient amount of sales to the customers. Demographical and behavioral data (i.e., a set of independent variables and their values) is collected for the set of past customers. Example of such data includes age, sex, income, geographical location, products purchased, time since last purchase, etc. Sales data from those customers for previous catalogs is also collected. Examples of sales data includes the identity of catalog recipients who bought products from a catalog and those who chose not to buy any products (i.e., dependent variable).

The prediction model based on this collected sales data applies the most relevant independent variables, their assigned weights, and their acceptable range of values to determine the customers that should receive the future catalog. The prediction model detects the ideal customer to target, and the potential customers can be filtered based on this ideal. Certain customers may be targeted because the probability of them buying a product is high due to their demographical and behavioral characteristics.

For this example, an analyst may create a prediction model by determining characteristics of consumers that indicate they will buy a product. Thus, creating a prediction model involves determining how strongly a group of traits corresponds to the probability that a consumer having that trait or group of traits will buy a product from the catalog. Ideally, an analyst tries to use as few traits (i.e., independent variables) as possible in the model to ensure its accurate application across many different diverse sets of customers. However, the analyst must employ enough traits in the model to realize a sufficient number of customers who will buy products.

Analysts create these prediction models through statistical processes and market experience to determine the relevant traits or/and groupings and the weight given to each. However, creating a prediction model has largely been a manual task, requiring the analyst to physically manage each step of the creation process such as data cleansing, data reduction, and model building. Each time the analyst includes new criteria in the process or each time a different approach is used, the analyst must begin from scratch and physically manage each step of the way. The process is inefficient and leads to ineffective prediction models because accuracy can be achieved only through multiple iterations of the creation process.

Furthermore, the experience gained by analysts through many prediction model iterations occurring over the course of many years has not been preserved for use in subsequent models. Each new analyst must gain his own knowledge of the relevant market when creating a prediction model to produce an effective result. In effect, each new analyst that attempts to generate the ideal prediction model must reinvent the wheel for the relevant market. Furthermore, each new analyst must be trained to understand the individual steps of the relevant model creation process. This training process can reduce efficiency by preventing new analysts from being productive relatively quickly and by lowering experienced analysts' productivity because they are overly involved in the new analysts' training process.

### SUMMARY

Aspects of the present invention provide a prediction model creation method and apparatus as well as a method and apparatus for training analysts to create prediction models. Embodiments of the present invention allow various statistical techniques to be employed. Some embodiments also allow the various statistical techniques and weights given to various parameters to be selected by the user and be preserved.

One embodiment of the present invention is a computer-implemented method for creating a prediction model. The method involves accessing from storage media representative data for a plurality of independent variables relevant to the prediction model to be created. The representative data is processed to eliminate one or more of the plurality of independent variables and to infer data where an instance of representative data for an independent variable is missing. A prediction model based on the independent variables that were not eliminated, the representative data input to the computer, and the inferred data is then generated.

Another embodiment of the present invention which is also a computer-implemented method for creating a prediction model includes sampling representative data for a plurality of independent variables relevant to the prediction model to be created to reduce the amount of data to process. The sampled representative data is processed to eliminate one or more of the plurality of independent variables. The method further involves generating a prediction model based on the independent variables that were not eliminated and the sampled representative data input to the computer.

Another embodiment of the present invention which is also a computer-implemented method for creating a prediction model also involves sampling representative data for a plurality of independent variables relevant to the prediction model to be created to reduce the amount of data to process. The sampled representative data is processed to infer data where an instance of representative data for an independent variable is missing. A prediction model is generated that is based on the independent variables, the sampled representative data input to the computer, and the inferred data.

Another embodiment of the present invention is a computer-implemented method for evaluating a prediction model in view of an alternate prediction model. The method includes accessing from storage media representative data for a plurality of independent variables relevant to the prediction model to be evaluated and processing the prediction model based at least on one or more of the independent variables and the representative data to produce a power of segmentation curve. The method further includes processing the alternate prediction model based on at least one or more of the independent variables and the representative data to produce an alternate power of segmentation curve. The area under the power of segmentation curve is computed as well as the area under the alternate power of segmentation curve. The area under the power of segmentation curve is compared to the area under the alternate power of segmentation curve to evaluate the prediction model.

Another embodiment is a computer-implemented method for creating a prediction model for a dichotomous event. This method includes accessing from storage media representative data for a plurality of independent variables relevant to the prediction model to be created and dividing the representative data into two groups. The first group includes the representative data taken for an occurrence of a first dichotomous state, and the second group includes the representative data taken for an occurrence of a second dichotomous state. Statistical characteristics of the representative data for the first group and the second group are computed, and independent variables having unreliable statistical characteristics from either the first group, the second group, or from both the first and second groups are detected. The independent variables detected as having unreliable statistical characteristics are eliminated, and a prediction model based on the independent variables that were not eliminated and the representative data input to the computer is created.

The present invention also includes a computer-implemented method for training prediction modeling analysts. This method involves displaying components of the prediction model creation process on a display screen and receiving a selection from a user of one or more components from the operational flow being displayed. The one or more selected components may be employed on underlying modeling data and variables. The result of the operation of the one or more selected components is displayed.

Another embodiment that is a computer-implemented method for creating a prediction model involves accessing from storage media representative data for a plurality of independent variables relevant to the prediction model to be created. The method further involves receiving one or more modeling switch selections to configure a modeling process used when creating the model from the plurality of independent variables and representative data. The representative data and the plurality of independent variables are processed according to the received modeling switch selections to generate a prediction model based on the independent variables and the representative data.

### DESCRIPTION OF DRAWINGS

FIG. 1A illustrates a general-purpose computer system suitable for practicing embodiments of the present invention.

FIG. 1B shows a high-level overview of the operational flow of an exemplary run mode embodiment.

FIG. 1C shows a high-level overview of the operational flow of an exemplary training mode embodiment.

FIG. 2 depicts a detailed overview of the operational flow of an exemplary prediction model creation process.

FIG. 3 shows the operational flow of the sampling process of an exemplary embodiment.

FIG. 4A depicts the operational flow of the data cleansing process of an exemplary embodiment.

FIG. 4B depicts the operational flow of an exemplary Means/Descriptives operation of FIG. 4A in more detail.

FIG. 5 illustrates the operational flow of a missing values process of an exemplary embodiment.

FIG. 6 shows the operational flow of a new variable process of an exemplary embodiment.

FIG. 7 illustrates the operational flow of a preliminary modeling process of an exemplary embodiment.

FIG. 8 shows the operational flow of a final modeling process of an exemplary embodiment.

FIG. 9 illustrates a power of segmentation curve for a prediction model in relation to an expected reference result's curve.

### DETAILED DESCRIPTION

Various embodiments of the present invention will be described in detail with reference to the drawings, wherein like reference numerals represent like parts and assemblies through the several views. Reference to various embodiments does not limit the scope of the invention, which is limited only by the scope of the claims attached hereto.

Embodiments of the present invention provide analysts with a computer-implemented tool for developing and evaluating prediction models. The embodiments combine various statistical techniques into structured procedures that operate on representative data for a set of independent variables to produce a prediction model. The prediction model can be validated and compared against other models created for the same purpose. Furthermore, some embodiments provide a training procedure whereby new analysts may interact with and control each operational component of the creation model process to facilitate understanding the effects of each operation.

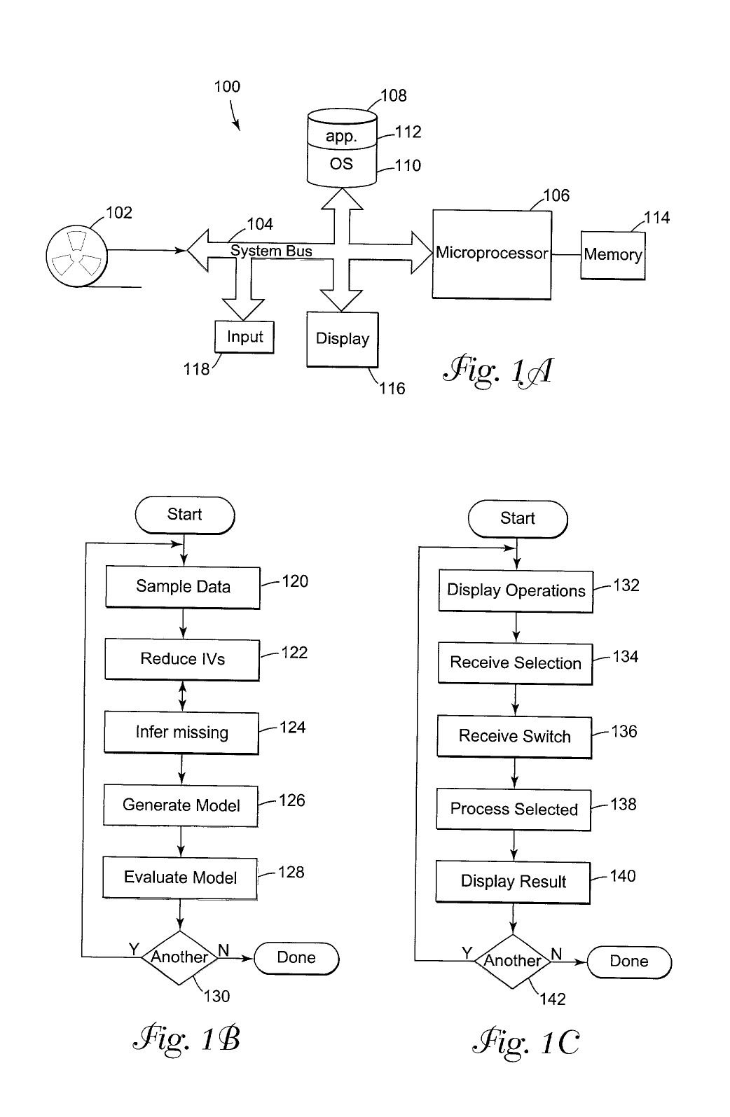

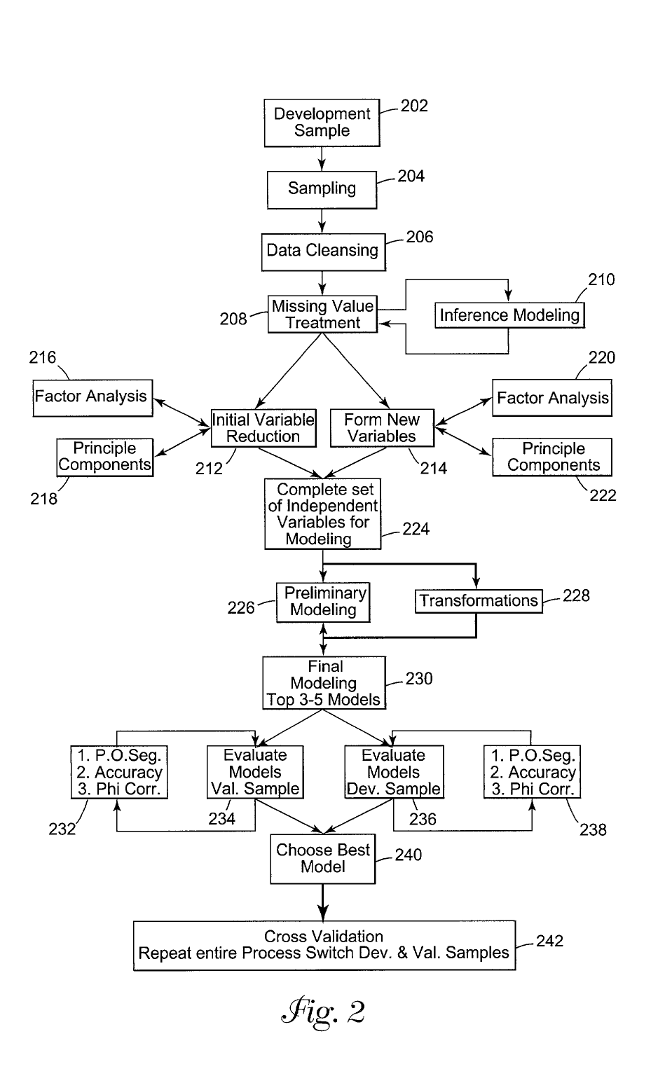

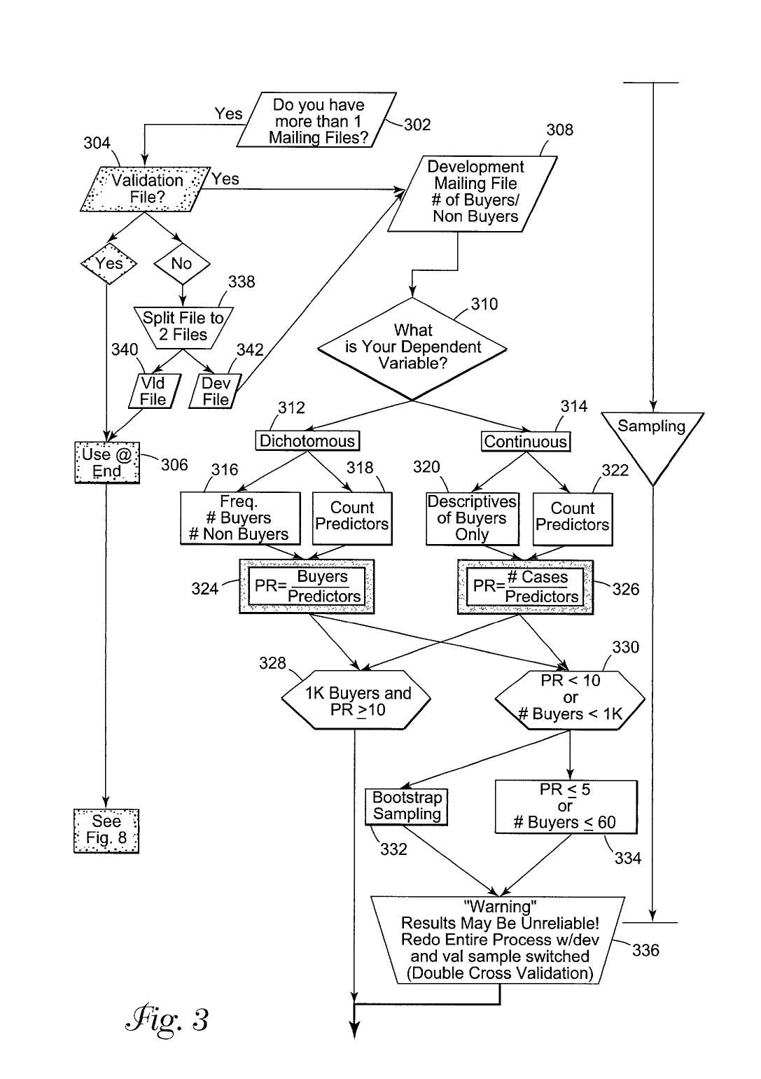

FIG. 1A shows an exemplary general-purpose computer system capable of implementing embodiments of the present invention. The system 100 typically contains a representative data source 102 such as a tape drive or networked database. The data source 102 is linked to a general-purpose computer including a system bus 104 for passing data and control signals between a microprocessor 106 and any peripherals such as a video display device 116 as well as local storage devices 108. The microprocessor 106 utilizes system memory 114 to maintain and alter data utilized in performing the various operations of the model creation process.

The microprocessor 106 is typically a general-purpose processor that implements embodiments of the present invention as an application program 112. The general-purpose processor may be implementing an operating system 110 also stored on the local storage device 108 and resident in memory 114 during operation. Embodiments of the present invention also may be implemented in firmware or hardware of the general-purpose computer or of application-specific devices.

The representative data grouped according to the corresponding independent variables is generally a very large data set. For example, a catalog company may maintain data for 3 thousand variables per customer for 10 million customers. Therefore, the large data set may be maintained on magnetic tape 102 or in other high capacity storage devices. The microprocessor 106 requests the data when the prediction model process begins and the data is supplied to the microprocessor through the system bus 104. If the data already has been sampled, then a smaller data set results and an external data source may not be necessary for the sampled data set.

The microprocessor implements the operational flow as described below with reference to FIG. 1B to utilize the representative data and corresponding independent variables to produce the prediction model. The training mode embodiments typically perform in a similar manner but utilize a different high-level operational flow as described below with reference to FIG. 1C. In either case, the computer system 100 facilitates user interaction by displaying the prediction creation process options on the display 116 and receiving user input through an input device 118, such as a keyboard or mouse. Model evaluation results also are displayed on the display device 116.

FIG. 1B shows a high-level operational flow of an exemplary embodiment of the prediction model creation process. This process is typically used by an analyst who wishes to quickly generate prediction models through several iterations to fine-tune the model for the best performance. The process may begin once the microprocessor 106 has received data by a sampling process 120 extracting representative data for a set of independent variables from the complete data source available from the data source 102. Various sampling methods may be chosen and configured by the analyst to extract the representative data. The sampling process may be omitted but the modeling process will be more computationally intensive.

Once the data set to be used for the model creation process has been extracted, the independent variables that correspond to the data in the set are reduced by reduction process 122. This process may utilize numerous variable reduction methods as chosen and adjusted by the analyst. This process may be omitted but the modeling process could result in a prediction model that is overfit to the representative data and therefore, not accurate for other data sets. A validation process, discussed below, can be implemented to detect an overfitted prediction model. Overfitting occurs where the model is matched too closely to the data set used for model creation, typically because of too many independent variables, and becomes inaccurate when applied to different data sets.

The representative data for the independent variables to be used are checked to see if any values are missing at inference operation 124. The missing values are then replaced by inferring what they would be. Various techniques for inferring the missing values can be used as chosen and adjusted by the analyst. This process may be omitted, but the missing values may adversely affect the resulting model; or the records with one or more missing values may be omitted altogether, thereby limiting the representative samples available.

Once the missing values have been treated, control may return to independent variable elimination operations 122 to continue reducing the number of independent variables. The continued reduction is based in part on the values substituted for the missing values that were previously determined. After the additional independent variables have been eliminated, the most relevant independent variables should remain, and the data set for those variables is ready for modeling.

Once the data set for the remaining independent variables is ready, the prediction model may be generated by various statistical techniques including logistical or linear regressions at model operation 126. Regressions are linear or logical composites of independent variables and weights applied thereto resulting in a mathematical description of a model. The model that results indicates the ranges of values for the key independent variables necessary for determining the result (i.e., dependent variable) to be predicted. After the model is generated, it generally needs to be validated and tested for its effectiveness at evaluation process 128.

The model can be validated for accuracy and performance by comparing the results of applying the model to the development data sample with the results of applying the model to a different data sample known as a validation sample. This validation determines whether the model is overfit to the development sample or equally effective for different data sets. Cross validation may be implemented to further determine the effectiveness of the model and can be achieved by applying the validation sample to the final model algorithm to recalculate the weights given to each independent variable. This reweighted model is then applied to the development sample and the accuracy and performance is compared to the first model.

If the development sample is relatively small, then the chance of obtaining an overfitted model is more likely. In that case and others, a double cross validation may also be desirable to check for the overfit. The double cross validation is achieved by independently creating a model using the validation sample and then cross validating that model. The two cross validations are compared to determine whether the models have inaccuracies or have become ineffective.

Query operation 130 then determines whether the analyst wishes to create additional models. Query operation 130 may function before model validation, cross validation, and double cross validation is performed to permit several models to be created. If only a single model was created by the first iteration and multiple models for the same development sample are desired for comparison before choosing one or more to fully validate, the analyst can invoke query operation 130. If another modeling attempt is desired, control returns to sampling operation 120. Otherwise, the creation process terminates.

FIG. 1C illustrates the operational flow of an exemplary training mode embodiment. The training mode includes instruction background text, explaining each statistical concept or procedure. This mode also contains example code and training data sets for each process. In this embodiment, the user typically wishes to proceed step-by-step, or section-by-section through the model creation process and view the effects each step or decision produces. The training mode embodiment allows the analyst to quickly train him or herself and gain intuition without additional assistance from other analysts.

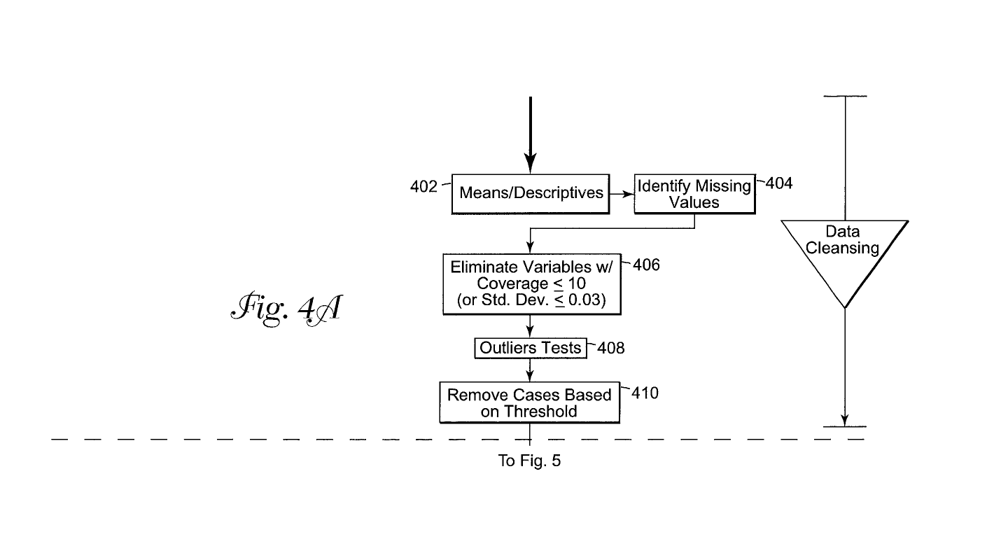

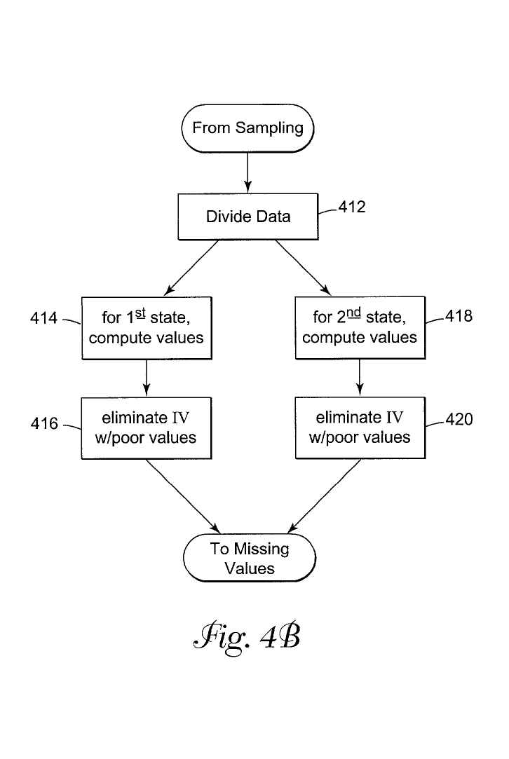

The training mode begins at display operation 132 which provides an image of the operational components of the creation process to the display screen 116. The operational components displayed may be at various levels of complexity, but typically the components correspond to those as discussed below and shown in FIG. 2 and/or FIGS. 3-8. After the operational components are displayed, input operation 134 receives a selection from the user through the input device. The user typically will select one or more components to implement on demonstration data or real data sets.

After having selected the one or more components to demonstrate, the user enters the selections for the modeling switches, such as decision threshold values, that govern how each component operates on the representative data and/or corresponding independent variables. In the fall implementation of the process, the modeling switches govern the processing of the data and independent variables and ultimately the prediction model that results. As mentioned for the creation process operation of FIG. 1B, the analyst may choose and adjust the various statistical methods. The model switches provide that flexibility, and the user of the training mode can alter the switches for one or more components to see on a small scale how each switch alters the chosen component's result. The modeling switch selections are received at input operation 136.

Once the components and switches have been properly selected by the user, the selected components are processed on the representative data according to the switch settings at process operation 138. Control then moves to display operation 140. If demonstration data is used, the process operation may be omitted because the result for the selected components and switches may have been pre-stored. Control moves directly to display operation 140 where the results of the component's operation are displayed for the user. After the result is displayed, query operation 142 detects whether another attempt in the training mode is desired, and control either returns to display operation 132 or it terminates.

The training mode may be implemented in HTML code in a web page format, especially when demonstrative data and pre-stored results are utilized. This format allows a user to implement the process through a web browser on the computer system 100. The web browser allows the user to move forwards and backwards through the operational flow of FIG. 1C. Furthermore, this HTML implementation provides the ability to disseminate the training mode process through a distributed network such as the Internet that is linked through a communications device such as a modem to the system bus 104.

FIG. 2 shows the exemplary embodiment of the prediction model creation process of FIG. 1B in more detail. The development sample 202 is provided to the computing device typically from the external data source 102. The microprocessor implements the prediction model creation process to first access the stored data to extract a representative development sample at sampling operation 204.

After the representative sample has been extracted, data cleansing operation 206 eliminates data that may adversely affect the model. For example, if the data coverage for a given independent variable is very small, all data for that independent variable will be considered ineffective and the independent variable will be removed altogether. If a data point for an independent variable is far different than the normal range of deviance, then the data instance (i.e., customer record) containing that data point for an independent variable may be eliminated or the data value may be capped. As will be discussed, the data point itself may also be removed and subsequently replaced by inferring what a normal value would be in a later step.

After the data has been cleansed, missing values within the representative data for the independent variables still remaining will be treated at value operation 208. This operation may call upon an inference modeling operation 210 to determine what the missing values should be. Simple prediction models may be constructed to determine suitable values for the missing values. Other techniques may be used as well, such as adopting the mean value for an independent variable across the data set.

Once the data has been cleansed and the missing values have been treated, the independent variables for the cleansed and treated data set are reduced again. This variable reduction may involve several techniques at reduction operation 212 such as detecting variables to be eliminated because they are redundancies of other variables. Other methods for eliminating independent variables are also employed. Control proceeds to factor analysis processing at factor operation 216 once variables have already been reduced by operation 212. After factor operation 216, principle operation 218 may be utilized to employ principle component techniques to further reduce the variables.

Factor analysis and principle components processing each reduces variables by creating one or more new variables that are based on groups of highly correlated independent variables that poorly correlate with other groups of independent variables. Some or all of the independent variables in the groups corresponding to the new variables produced by factor analysis or principle components may be maintained for use in the model if necessary. In operations 216 and 218, however, the primary purpose is to reduce variables by keeping only variable combinations.

If reduction operation 212 is not desirable, variable operation 214 bypasses operation 212 and sends control directly to factor operation 220. Factor operation 220 operates in the same fashion as factor operation 216 by applying factor analysis processing to create new variables from groups of highly correlated independent variables. Then control may pass to components operation 222 which also creates new variables using principle components processing. In operations 220 and 222, the primary purpose is to create additional unique variables.

Once the data has been sampled, cleansed, treated for missing values, and variables have been reduced, the data set and variables are complete for modeling. At stage 224, the most result-correlated independent variables are maintained for preliminary modeling that begins at modeling operation 226. This operation involves additional attempts to detect correlation between the independent variables and between each independent variable and the dependent variable. The preliminary modeling operation 226 applies transformation operation 228 to the development data for the independent variables existing at this stage to create an error that is normally distributed for the data relative to the dependent variable that is suitable for final model regressions.

Modeling operation 230 then performs final modeling by taking the remaining independent variables and development data and generating a regression for the variables according to the development data for the independent variables and the dependent variable. Where multiple models have been constructed in parallel, each model is evaluated by operation 236 applying the model to the development sample. The accuracy of each model resulting from the regression is measured by comparing the actual value to the value predicted by the models for the dependent variable at evaluation operation 238. The segmentation power of the model, which is the model's ability to separate customers into unique groups, is also evaluated in operation 238.

The validation sample is applied to the created model at validation operation 234 to produce a result. The result from the validation sample is also checked for accuracy and effectiveness at evaluation operation 232. The best models are then evaluated based on their power of segmentation and accuracy for both the development and validation sample at best model operation 240. Cross-validation is utilized on the best model selected by applying the validation sample to the final model algorithm to reweight the independent variables at validation operation 242. The accuracy and power of segmentation of the reweighted model when applied to both the development and validation sample data can then be compared to further analyze the model's efficacy.

FIG. 3 shows the sampling operation 204 in more detail. As shown, the sampling operation is directed to a catalog example and is set up to operate on data for either a dichotomous or continuous dependent variable (such as whether a customer will buy a product from the catalog or how much money a customer is expected to spend on purchases from the catalog). The sampling operation begins by query operation 302 detecting whether there are more than 1 mailing file from which to take samples. In this example, a mailing file would be a set of information from a past catalog mailing indicating the demographical and behavioral data for the customers and whether they bought products from this particular catalog.

If there are multiple mailing files, then query operation 304 determines that a spare file is available from the multiple mailing files to be used as a validation file. The validation file is saved for later use at operation 306. If a validation file is not available because there is only one mailing file, then split operation 338 divides the available mailing file into the separate files, a validation file 340 and a development file 342. Again, the validation file is saved for later use at operation 306.

After a development file is known to be available in this example, a set of buyers and non-buyers are extracted from the mailing file at file operation 308. The size of the set is dependent upon design choice and the number of customers available in the file. Various methods for sampling the data from the file may be used. For example, random sampling may be used and a truly representative sample is likely to result.

However, if a dependent variable state is relatively rare, random sampling may result in data that does not fully represent the characteristics of the customers yielding that state. In such a case, stratified sampling may be used to purposefully select more customers for the sample that have the rare dependent variable value than would otherwise result from random sampling. A weight may then be applied to the other category of customers so that the stratified sampling is a more accurate representation of the mailing file.

After a sampling has been extracted, query operation 310 determines whether a dichotomous dependent variable 312 (i.e., buy vs. don't buy) or a continuous variable 314 (i.e., amount spent) will be used. If a dichotomous variable is detected, then buyer operation 316 computes the number of available buyers in the development data set. Variable operation 318 computes the number of independent variables (i.e., predictors) that are present for the representative development data. Predictor operation 324 then computes a predictor ratio (PR) which is the number of buyers in the sample divided by the number of predictors.

In this example, if query operation 310 detects a continuous dependent variable, then buyer operation 320 computes the number of buyers who have paid for their purchases. Variable operation 322 computes the number of predictors that are present for the development data. Predictor operation 326 then computes a PR which is the number of cases (i.e., buyers) divided by the number of predictors.

Query operations 328 and 330 detect whether the number of buyers are greater or less than a selected threshold and whether the predictor ratio is greater or less than a selected threshold. Each of the selected thresholds is configurable by a modeling switch whose value selection is input by the user prior to executing the sampling portion of the creation process. These thresholds will ultimately affect the efficacy of the prediction model that results and may be modified after each iteration.

If the number of buyers is greater than the threshold and the predictor ratio is also greater than the threshold, then the sampled development data is suitable for application to the remainder of the selection process. Once the development data is deemed suitable, the sampling process terminates and this exemplary creation process proceeds to the data cleansing operation. Other embodiments may omit the sampling portion and proceed directly to the data cleansing operation or may omit the data cleansing portion and proceed to another downstream operation.

If the number of buyers or the predictor ratio is less than the respective thresholds, then the development sample may be inadequate. Sample operation 332 may then be employed to perform bootstrap sampling which creates more samples by resampling from the development sample already generated to add more samples. Several instances of a single customer's data may result and the mean values for the samples will be exaggerated, but the additional samples may satisfy the buyer and predictor ratio thresholds. Query operation 334 detects whether the predictor ratio or number of buyers are below respective critical thresholds, also setup by the modeling switch selections. If so, a warning is provided to the user at display operation 336 before proceeding to data cleansing operations to indicate that the resulting model may be unreliable and that double cross-validation should be implemented to prevent overfitting and to otherwise ensure accuracy.

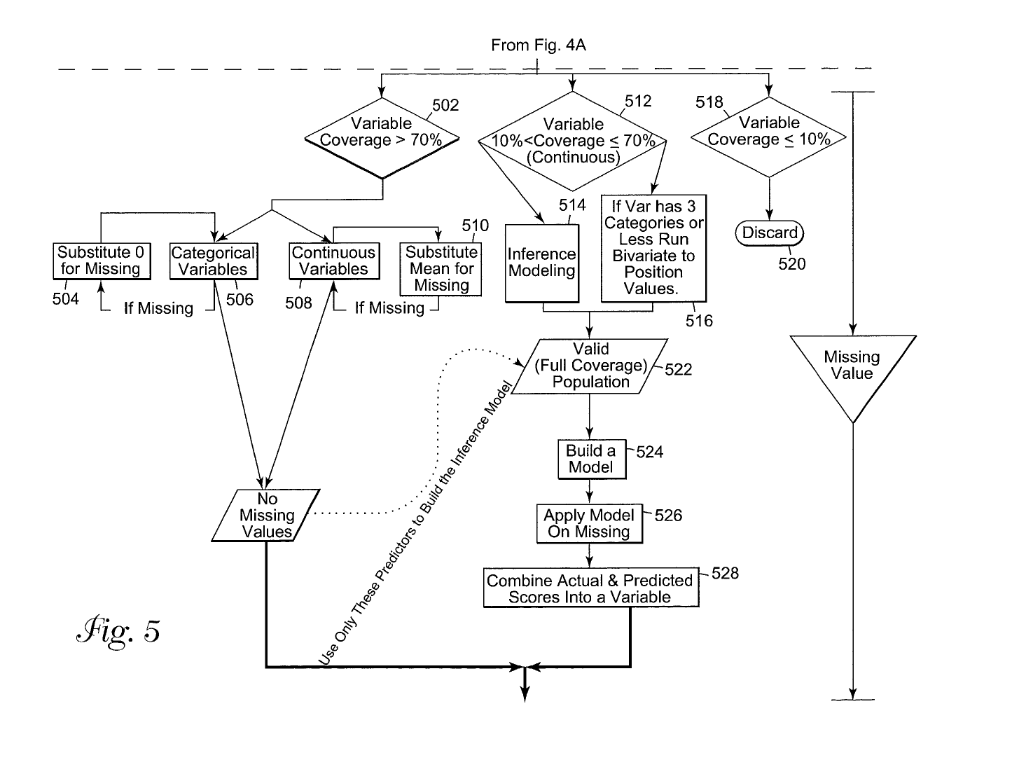

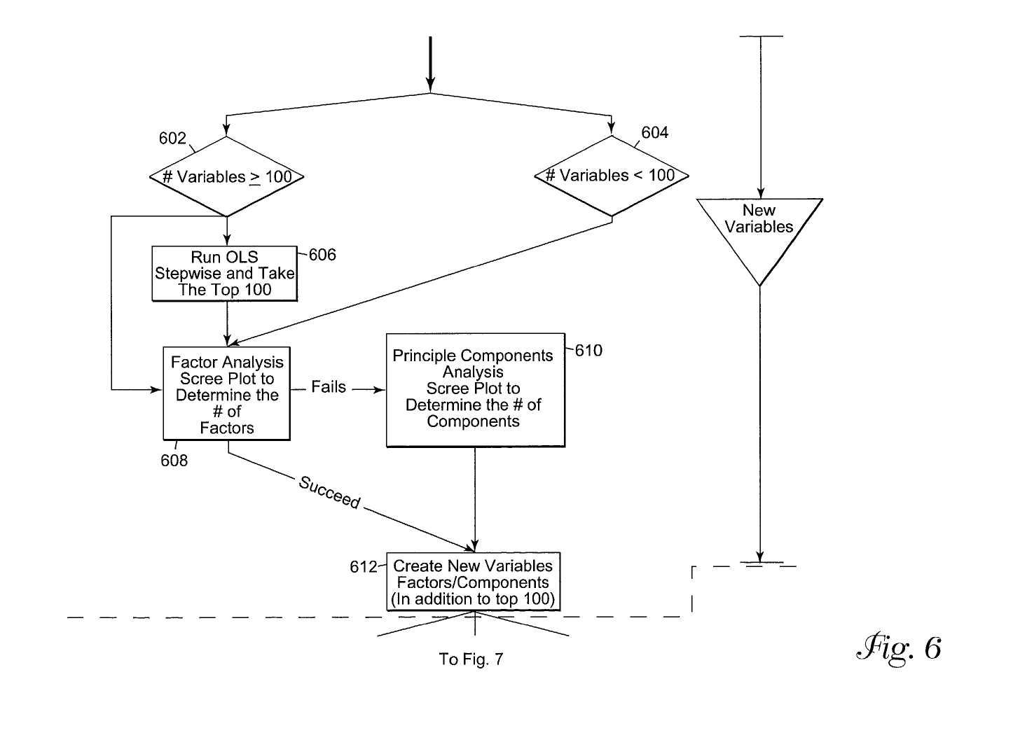

FIG. 4A illustrates the data cleansing operations in greater detail. After the data has been properly sampled, a variable operation 402 computes statistical qualities for the data values for each independent variable. These include but are not limited to the mean value, the number of sample values available, the max value, the min value, the standard deviation, t-score (difference between the mean value for independent variable data producing one result and the mean value for the independent variable data producing another result), and the correlation to other independent variables. Exemplary steps for one embodiment of variable operation 402 is shown in greater detail in FIG. 4B.

In this variable operation, which applies for dichotomous dependent variables, the data is divided into two sets corresponding to data for one dependent variable state and data for the other state. For example, if the two states are 1. bought products, and 2. didn't buy products, the first data set will be demographical and behavioral data for customers who did buy products and the second data set will be demographical and behavioral data for customers who did not buy products. The independent variables are the same for both sets, but the assumption for prediction model purposes is that data values in the first set for those independent variables are expected to differ from the data values in the second set. These differences ultimately provide the insight for predicting the dependent variable's state.

After the data is divided into the two sets, value operation 414 computes the statistical values including those previously mentioned for each of the independent variables for the data from the first set. After the values have been computed, elimination operation 416 detects independent variables having one or more faults. Elimination operation 416 is explained in more detail with reference to several data cleansing operations shown in FIG. 4A and discussed below, such as detecting missing data values that result in poor variable coverage and detecting inadequate standard deviations.

Value operation 418 computes the same statistical values for each of the independent variables for the data from the second set. After these values have been computed, elimination operation 420 detects independent variables having one or more faults. Similar to elimination operation 416, elimination operation 420 is also explained in more detail with reference to the several data cleansing operations shown in FIG. 4A.

Once the statistical values have been computed for the independent variables at variable operation 402, the missing data values for each independent variable are detected at identification operation 404. This operation is applied to all data, and may form a part of elimination operations 416 and 420 shown in FIG. 4B. The missing data values for an independent value may be problematic if there are enough instances.

Elimination operation 406, which may also form a part of elimination operations 416 and 420, detects instances of faulty data for independent variables by detecting, for example, whether the coverage is too small (i.e., too many missing values) based on a threshold for a given independent variable. This threshold is again user selectable as a modeling switch. Elimination operation 406 may detect faulty data in other ways as well, such as by detecting a standard deviation that is smaller than a user selectable threshold. Independent variables who have faulty data statistics will be removed from the creation process.

Outliers operation 408, which may also form a part of elimination operations 416 and 420, detects instances of data for an independent variable that are anomalies. Anomalies that are too drastic can adversely affect the prediction model. Therefore, the detected outlier values can be eliminated altogether if beyond a specified amount and replaced by downstream operations. Alternatively, a user selectable cap to the data value can be applied.

Threshold operation 410, which may also form a part of elimination operations 416 and 420, removes independent variables based on thresholds set by the user for every statistical value previously computed. For example, if one independent variable has a high correlation with another, then one of those is redundant and will be removed. Once the independent variables having faulty data have been removed, operational flow of the creation process proceeds to the missing values operations to account for independent variables having less than ideal coverage.

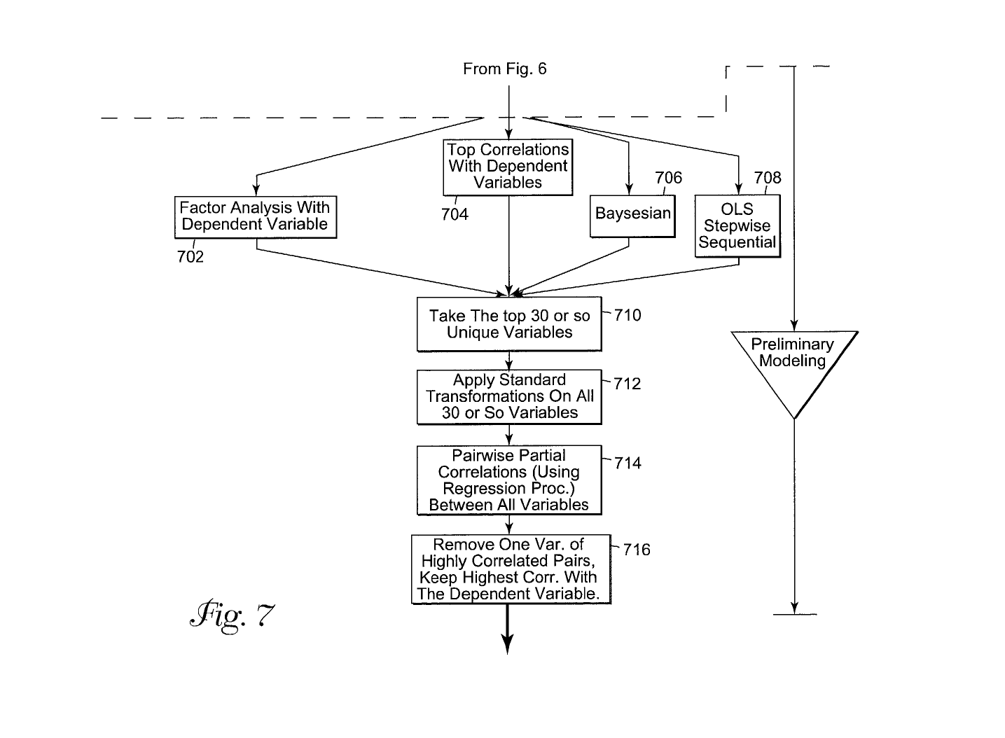

FIG. 5 shows the missing values operation 208 in greater detail. Three query operations 502, 512, and 518 detect for each independent variable the number of missing data values in the representative development data set from the results of the data cleansing operation 206 shown in FIG. 4A. If query operation 502 detects that an independent variable has coverage above a high threshold, as selected by the user, then the missing values can be treated to produce value state 530 indicating that those variables are ready for implementation in the new variables operations. For categorical (i.e., dichotomous) independent variables determined to have missing values at variable operation 506, a zero may be substituted for each missing value at value operation 504. For continuous independent variables determined to have missing values at variable operation 508, the mean for all of the data values for that variable may be substituted for each missing value at operation 510.

Query operation 512 detects whether the number of missing values in the representative development data set fall within a range, as selected by the user, where more complex treatment is possible and required. Inference modeling operation 514 is employed to predict what the missing values would be. Bivariate operation 516 may be employed as well for some or all of the independent variables with missing values to attempt an interpolation of the existing values for the independent variable of interest to find a mean value. This value may differ from the mean value determined in variable operation 402 of FIG. 4A and may be substituted for the missing values.

If the bivariate operation 516 is unsuccessful for one or more independent variables or is not employed, the inference modeling proceeds by creating a full coverage population for all other independent variables for the data set that have no missing values. Independent variables previously treated and resulting in state 530 may be employed. The inference model is built at modeling operation 524, which creates the inference model by treating the independent variable with the missing value as a dependent variable. Modeling operation 524 employs the prediction model process of FIG. 2 on the selected independent variables and their data values to generate the inference model. The inference model is then applied to the available data set to predict a value for the independent variable of interest at model operation 526.

Once the missing values have been predicted for each independent variable falling within the range detected by query operation 512, the predicted variables are included in the data set along with the actual values that are available for the independent data set at combination operation 528. The independent variables within the range detected by query operation 512 are ready for the new variable operations of the modeling process. The independent variables detected by query operation 518 have a high number of missing values that exceed the modeling switch selected threshold and are removed at discard operation 520 and do not further influence the model.

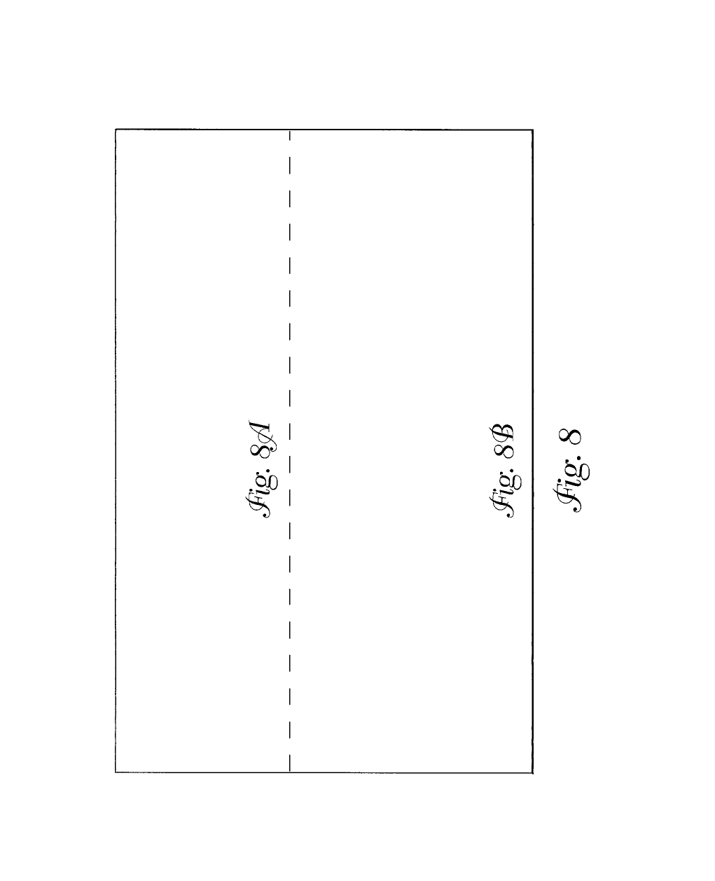

FIG. 6 illustrates the new variables operation whose ultimate objective is to arrive at a relevant set of variables for preliminary modeling. Initially, query operations 602 and 604 detect whether the number of independent variables remaining in the modeling process are greater than or less than a modeling switch selected threshold. If the number of variables is greater than the threshold, as detected by query operation 602, then an Ordinary Least Squares (OLS) Stepwise or other multiple regression method can be applied to the independent variables and their data resulting in a hierarchy of variables by weight in the resulting equation. A multiple regression is a statistical procedure that attempts to predict a dependent variable from a linear composite of observed (i.e., independent) variables. A resulting regression equation is as follows:

Y′=A+B₁X₁+B₂X₂+B₃X₃+ . . . +BₖXₖ

where

Y′=predicted value for the dependent variable

A=the Y intercept

X=the independent variables from 1 to k

B=Coefficient estimated by the regression for each independent variable

Y=actual value for the dependent variable

The top ranked variables from the hierarchy determined from the multiple regression, as defined by a modeling switch, may be kept for the model while the others are discarded. Control then proceeds to factor operation 608.

If query operation 604 detects that the number of variables is less than the threshold, then operation may skip the multiple regressions and proceed directly to factor operation 608. At this operation, factor analysis is applied to the remaining independent variable data. Here, a number of factors as set by a modeling switch are extracted from the set of independent variables. Factor analysis creates independent variables that are a linear combination of latent (i.e., hidden) variables. There is an assumption that a latent trait does in fact affect the independent variables existing before factor analysis application. An example of an independent variable result from factor analysis that is a linear combination of latent traits follows:

X₁=b₁(F₁)+ . . . +b₂(F₂)+ . . . +b_{q}(F_{q})+d₁(U₁)

where

X=score on independent variable 1

b=regression weight for latent common factors 0 to q

F=score on latent factors 0 to 1

d=regression weight unique to factor 1

U=unique factor 1

If the factor analysis fails to satisfactorily reduce the number of independent variables, operational flow proceeds to components operation 610 which applies principle components analysis to the remaining independent variable data. Principle components analysis detects variables having high correlations with other variables. These highly correlated variables are then combined into a linearly weighted combination of the redundant variables. An example of a linearly weighted combination follows:

C₁=b₁₁(X₁)+b₁₂(X₂)+ . . . +b₁ₚ(Xₚ)

where

C=the score of the first principle component

b=regression weight for independent variable 1 to p

X=score on independent variable 1 to p

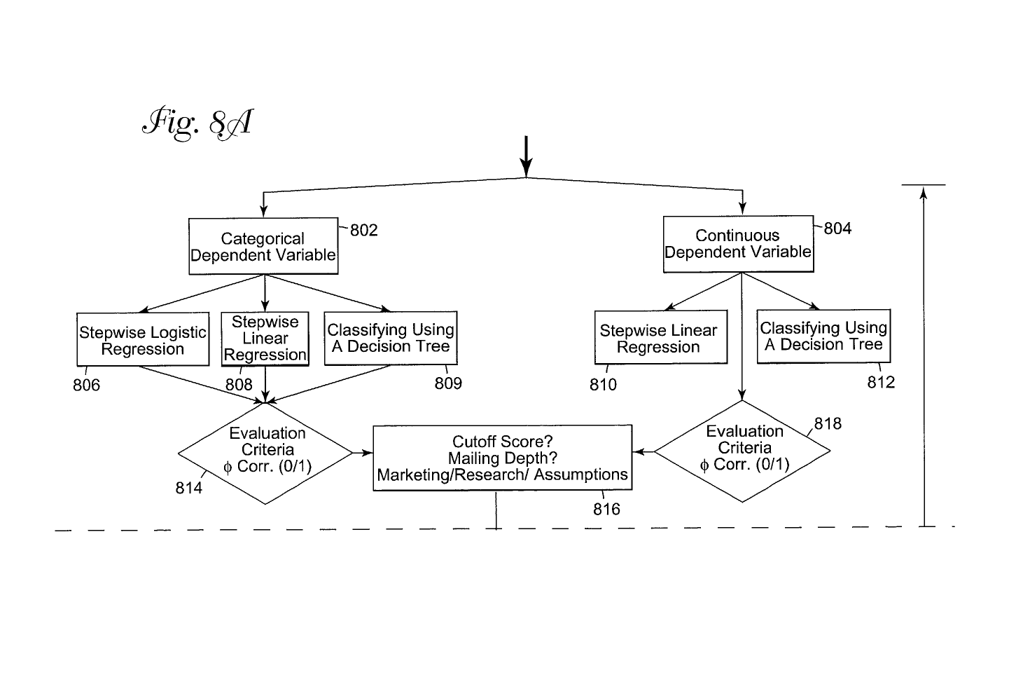

If either the factor analysis or the principle components succeeds, the new variables are then added into the modeling process along with the previously remaining independent variables at variable operation 612. This set of variable data is then utilized by the preliminary modeling operations shown in more detail in FIG. 7. The preliminary modeling operations are utilized to further limit the variables to those most relevant to the dependent variable.

In FIG. 7, the preliminary modeling operations begin by applying several modeling techniques to the set of variable data. At factor operation 702, factor analysis is reapplied but with the dependent variable included in the correlation matrix to further determine which variables most closely correlate with the dependent variable. Each independent variable is individually correlated with the dependent variable at correlation operation 704 to also determine which variables correlate most closely with the dependent variable.

Regression operations 706 and 708 apply a Bayesian and an OLS Stepwise sequential multiple regression, respectively, to the variable data to determine which variables are most heavily weighted in the resulting equations. Variable operation 710 then compares the results of the factor analysis, individual correlations, and regression approaches to determine which variables rank most highly in relation to the dependent variable. Those ranking above a modeling switch threshold are kept and the others are discarded. Transformation operation 712 applies a standard transformation to produce a normal error distribution between the independent variables remaining and the dependent variable's that resulted.

Correlation operation 714 then performs pair-wise partial correlations using a regression process between pairs of variables to again determine whether the remaining variables, after transformation, are highly correlative to each other and therefore, redundant. Selection operation 716 removes one of the variables from each redundant pair by keeping the independent variable of the pair who has the highest individual correlation with the dependent variable. After these redundancies have been removed, the variable data is ready for processing by the final modeling operations.

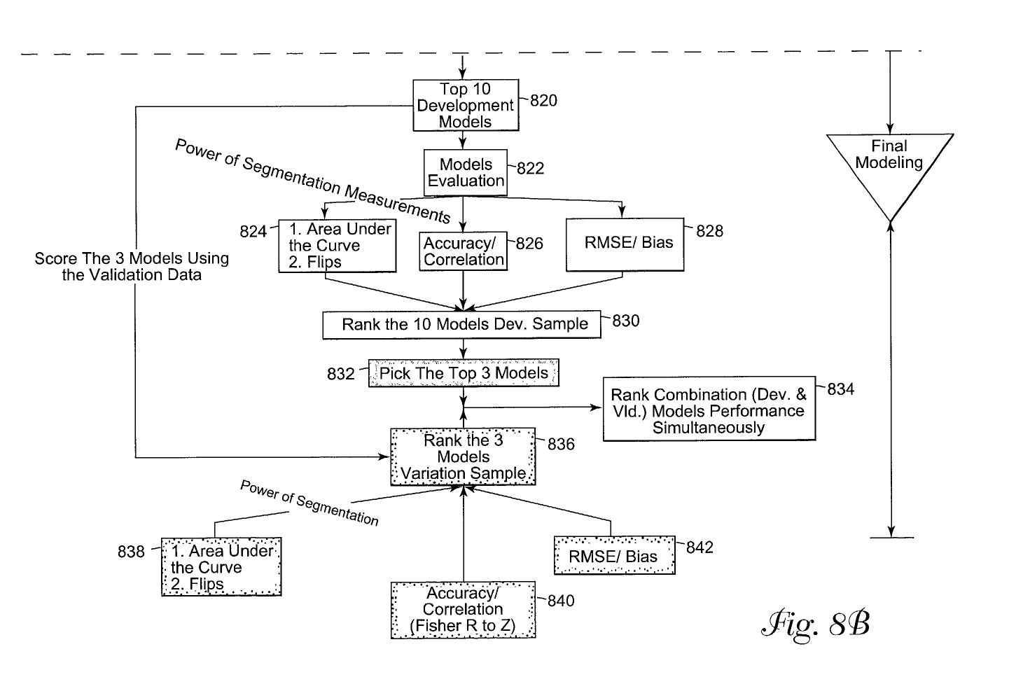

In final modeling shown in FIG. 8, if the dependent variable is of a categorical type 802 (i.e., dichotomous) regression operation 806 performs segmentation by a stepwise logistic regression on the variable data. A logistic regression generates the estimated probability from the non-linear function as follows:

e^{u}/(1+eᵤ)

where u=linear function comprised of the optimal group of predictor variables

Regression operation 808 performs segmentation by a stepwise linear regression on the variable data. The stepwise linear regression is a linear composite of independent variables that are entered and removed from the regression equation based only on statistical criteria. The independent variable data is also classified as to effect on the dependent variable using a binary tree at classification operation 809.

The results of the regressions and classification is compared by phi correlation operation 814. This operation calculates the accuracy of the model equations resulting from the regressions in relation to the classification tree based on the actual versus predicted values for the dependent variable.

If a continuous dependent variable type 804 exists, then a regression operation 810 provides segmentation by stepwise linear regression of the variable data, and classification operation 812 classifies the variable data in relation to the dependent variable's value using a decision tree. Evaluation operation 818 determines the phi correlation value to determine the accuracy of the model equation resulting from the regression in comparison to the classification.

The result of the evaluation operation 814 for a categorical dependent variable and evaluation 818 for a continuous dependent variable is analyzed at scoring operation 816. The efficacy of the resulting model equation is determined based on the evaluation score in comparison to a model switch cutoff score and mailing depth. Other model switch values may influence the score, such as marketing and research assumptions that can be factored in by applying weights to the evaluation score or cutoff score.

After the model equations have been evaluated, model operation 820 eliminates all models except those ranking above a model switch selection threshold. This operation is applicable where multiple models are created in one iteration such as by applying various thresholds to the same data set to produce different models and/or applying various regression techniques. Multiple models may also be collected over various iterations of the process and retained and reconsidered at each new iteration by model operation 820.

The top ranking models are then evaluated at operation 822 by applying power of segmentation measurements at evaluation operation 824. The top ranking models are also evaluated by applying an accuracy test such as the Fisher R to Z standardized correlation at operation 826. The top models are also evaluated by computing the root mean square error (RMSE) and bias at evaluation operation 828. The RMSE detects the square root of the average squared difference between the predicted and actual values and will detect whether a change has occurred. The bias is the measure of whether the difference between the predicted and actual values is positive or negative.

Each of these evaluation techniques results in a score for each model. Ranking operation 830 then analyzes the scores for each model in relation to the scores for other models to again narrow the number of models. The top models are chosen at operation 832.

The top ranked models are also validated at validation operation 836 to redetermine the top-most ranked models. As previously mentioned, validation occurs by applying the model equation with the pre-determined independent variable weights to a validation sample of the representative data which is a different set of data than the development sample used to create the model. The same evaluations are performed on the models as applied to the validation sample, including the power of segmentation at operation 838, accuracy by standardized correlation at operation 840, and RMSE/bias at operation 842. The best models are then selected from the validation sample application.

The evaluations for the top ranked models are then compared for both the top-ranked development models and the top-ranked validation models at best model operation 834. The model with the best summed score (i.e., sum of evaluation scores for the development sample plus sum of evaluation scores for the validation sample) may be selected as the best model. Other techniques for finding the best model are also possible. A single evaluation technique, for instance, may be used rather than several.

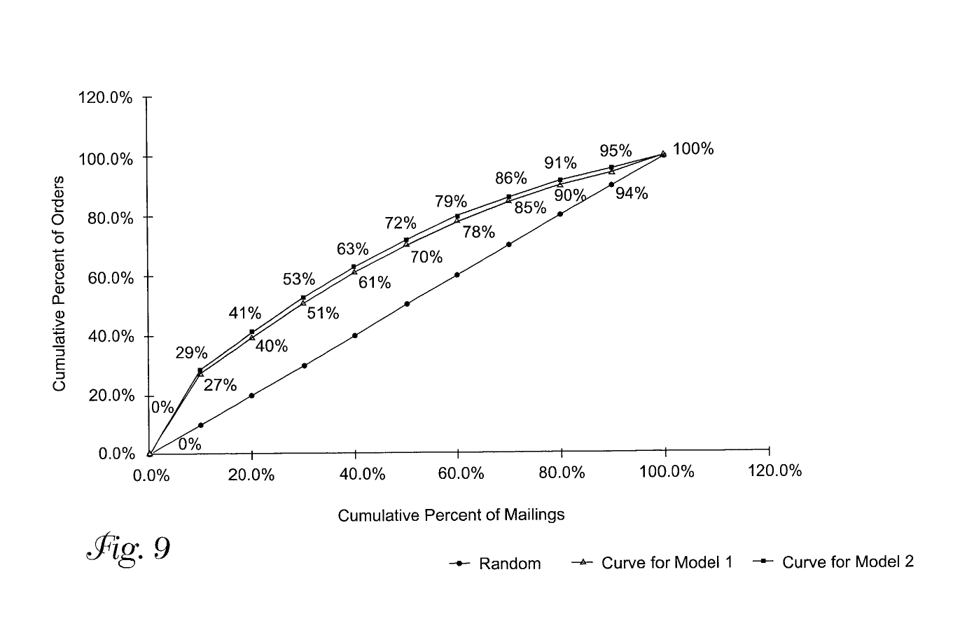

The power of segmentation method for evaluating the score of the model is illustrated in FIG. 9 for the catalog example used above. The power of segmentation score is computed by finding the area under the power of segmentation curve, shown in FIG. 9. In this example, the power of segmentation curve is achieved by fitting quadratic coefficients to the cumulative percent of orders (i.e., dependent variable=buy or no buy) on the cumulative percent of mailings (i.e., catalogs to the customers who provided the representative sample data).

As shown in FIG. 9, an expected line shows a 1:1 relationship between percent of mailings and percent of orders. The expected line illustrates what should logically happen in a random mailing that is not based on a prediction model. The expected line shows that as mailings increase, the number of orders that should be received increase linearly. Two prediction models' power of segmentation curves are shown arching above the expected line. These curves demonstrate that if the mailings are targeted to customers who are predicted to buy products, the relationship is not linear. In other words, if fewer than 100% of the catalogs are sent to the representative group, the sales can be higher than expected from a random mailing because mailings to customers who do not buy products can be avoided.

To see the benefits of the prediction models, the curve shows that 60% of mailings, when targeted, will result in nearly 80% of the sales. Thus, at that number of mailings, the prediction model suggests an increase in sales by 20% relative to a random mailing. This indicates that catalogs should be targeted according to the prediction model to increase profitability.

To see which prediction model is better, each prediction model's power of segmentation curve can be integrated. The model whose curve results in the greater area receives a higher score in the power of segmentation test. As shown in FIG. 9, the highest arching curve (model 2) will have more area than the curve for model 1. Therefore, model 2 receives a higher power of segmentation score.

As listed below, these embodiments may be implemented in SPSS source code. Sax Basic, an SPSS script language, may be implemented within SPSS. Interaction with various other software programs may also be utilized. For example, the variable operation 402 of FIG. 4A may result in Sax Basic within SPSS exporting the means and descriptives data to Microsoft Excel. Then SPSS may import the means and descriptives from Excel indexed by variable name.

Furthermore, to create the model, an SPSS regression syntax may be generated into an ASCII file by SPSS and then imported back into the SPSS code implementing the creation process as a string variable. An SPSS dataset may be generated and exported to a text file that is executed by SPSS as a syntax file to produce a model solution.

The training mode implementation, as mentioned, may be created in HTML to facilitate use of the training mode with a web browser. Furthermore, if the training mode is used on real data, the HTML code may be modified to interact with SPSS to facilitate user interaction with a web browser, real data, and real modeling operations.

Listed below is exemplary SPSS source code for implementing an embodiment of the model creation process. Other source code arrangements may be equally suitable.

SET MXMEMORY=100000.
SET Journal ‘C:\WINNT\TEMP\SPSS.JNL’ Journal On WorkSpace=99968.
*SET Journal ‘C:\WINNT\TEMP\SPSS.JNL’ Journal On Workspace=99968.
*SET OVars Both ONumbers Values TVars Both TNumbers Values.
*SET TLook ‘C:\Program Files\SPSS\Looks\Academic (VGA).tlo’ TFit Both.
*SET Journal ‘C:\WINNT\TEMP\SPSS.JNL’ Journal On Workspace=99968.
*SET OVars Both ONumbers Values TVars Both TNumbers Values.
*SET TLook ‘C:\Program Files\SPSS\Looks\Academic (VGA).tlo’ TFit Both.
/*** Get the data file ***/
GET

FILE=‘C:\workarea\DBI\R&D\Nits-BB\regtest614.sav’.

/*** See APPENDIX I ***/
INCLUDE file=‘C:\WORKAREA\DBI\R&D\nits-bb\varreduc\RECODE2MIS.SPS’.
/*** Create 2 variables: 1st is a correlation bet all IV’s and BUYIND ***/

| | |
|---|---|
| /*** | 2nd is the Fisher standartization of the 1st ***/ |
| CORRELATIONS | |

/VARIABLES= paccnum TO pboord14 pcancelw TO ppwtfboc procatlg TO d000msch

with BUYIND

/MISSING=PAIRWISE.

SCRIPT “C:\addapp\statistics\spssScripts\LAST Xport_to_Excel_(BIFF).SBS”

/(“C:\WORKAREA\DBI\R&D\Nits-BB\VarReduc\RBINVAR1.xls”).

CORRELATIONS

/VARIABLES= d000welf TO bbyes239 with BUYIND

/MISSING=PAIRWISE.

SCRIPT “C:\addapp\statistics\spssScripts\LAST Xport_to_Excel_(BIFF).SBS”

/(“C:\WORKAREA\DBI\R&D\Nits-BB\VarReduc\RBINVAR2.xls”).

CORRELATIONS

/VARIABLES= r000lif1 TO r000lowi r000ngol TO m000bcii with BUYIND

/MISSING=PAIRWISE.

| | | |
|---|---|---|
| /*** | Export Output Into Excel | ***/ |

SCRIPT “C:\addapp\statistics\spssScripts\LAST Xport_to_Excel_(BIFF).SBS”

/(“C:\WORKAREA\DBI\R&D\Nits-BB\VarReduc\RBINVAR3.xls”).

| | | |
|---|---|---|
| /*** | Input Excel Into Back SPSS | ***/ |

GET DATA /TYPE=XLS

/FILE=‘C:\workarea\DBI\R&D\Nits-BB\VarReduc\RBINVAR1.xls’
/SHEET=name ‘Sheet1’
/CELLRANGE=range ‘A2:C1338’
/READNAMES=on.

/*** Fisher r to z Standardization the Imported Correlation values ***/
RENAME VARIABLES v1=XVARNAME v2=ELIMINAT buyind=TEMP1.
COMPUTE RBUYIND=NUMBER(TEMP1,F7.3).
COMPUTE RZBUYIND=0.5*LN((1+RBUYIND)/(1-RBUYIND)).
EXECUTE.
FORMAT RBUYIND (F5.3).
FORMAT RZBUYIND (F5.4).
/*** Keep Only the Correlation Values Exclude Other Unnecessary Data ***/
SORT CASES BY

eliminat (A).

SELECT IF (SUBSTR(ELIMINAT,1,7)=‘Pearson’).
STRING VARNAME(A8).
COMPUTE VARNAME=SUBSTR(XVARNAME,1,8).
SAVE OUTFILE=‘C:\workarea\DBI\R&D\Nits-BB\VarReduc\CORR1.sav’

/KEEP varname rbuyind RZBUYIND /COMPRESSED.

GET DATA /TYPE=XLS

/FILE=‘C:\workarea\DBI\R&D\Nits-BB\VarReduc\RBINVAR2.xls’
/SHEET=name ‘Sheet1’
/CELLRANGE=range ‘A2:C1335’
/READNAMES=on.

RENAME VARIABLES v1=XVARNAME v2=ELIMINAT buyind=TEMP1.
COMPUTE RBUYIND=NUMBER(TEMP1,F7.3).
COMPUTE RZBUYIND=0.5*LN((1+RBUYIND)/(1-RBUYIND)).
EXECUTE.
FORMAT RBUYIND (F5.3).
FORMAT RZBUYIND (F5.4).
SORT CASES BY

eliminat (A) .

SELECT IF (SUBSTR(ELIMINAT,1,7)=‘Pearson’).
STRING VARNAME(A8).
COMPUTE VARNAME=SUBSTR(XVARNAME,1,8).
SAVE OUTFILE=‘C:\workarea\DBI\R&D\Nits-BB\VarReduc\CORR2.sav’

/KEEP varname rbuyind RZBUYIND /COMPRESSED.

GET DATA /TYPE=XLS

/FILE=‘C:\workarea\DBI\R&D\Nits-BB\VarReduc\RBINVAR3.xls’
/SHEET=name ‘Sheet1’
/CELLRANGE=range ‘A2:C303’
/READNAMES=on.

RENAME VARIABLES v1=XVARNAME v2=ELIMINAT buyind=TEMP1.
COMPUTE RBUYIND=NUMBER(TEMP1,F7.3).
COMPUTE RZBUYIND=0.5*LN((1+RBUYIND)/(1-RBUYIND)).
EXECUTE.
FORMAT RBUYIND (F5.3).
FORMAT RZBUYIND (F5.4).
SORT CASES BY

eliminat (A) .

SELECT IF (SUBSTR(ELIMINAT,1,7)=‘Pearson’).
STRING VARNAME(A8).
COMPUTE VARNAME=SUBSTR(XVARNAME,1,8).
SAVE OUTFILE=‘C:\workarea\DBI\R&D\Nits-BB\VarReduc\CORR3.sav’

/KEEP varname rbuyind RZBUYIND /COMPRESSED.

GET

FILE=‘C:\workarea\DBI\R&D\Nits-BB\VarReduc\CORR1.sav’.

EXECUTE.
ADD FILES /FILE=*

/FILE=‘C:\workarea\DBI\R&D\Nits-BB\VarReduc\CORR2.sav’.

EXECUTE.
ADD FILES /FILE=*
/FILE=‘C:\workarea\DBI\R&D\Nits-BB\VarReduc\CORR3.sav’.
EXECUTE.
SORT CASES BY

VARNAME (A).

SAVE OUTFILE=‘C:\workarea\DBI\R&D\Nits-BB\VarReduc\CORR_all.sav’

/KEEP varname rbuyind RZBUYIND /COMPRESSED.

/*** Get the original data file again ***/
GET

FILE=‘C:\workarea\DBI\R&D\Nits-BB\regtest614.sav’.

INCLUDE file=‘C:\WORKAREA\DBI\R&D\nits-bb\varreduc\RECODE2MIS.SPS’.
/*** Use only the data for the none-buyers. BUYIND = 0 ***/
TEMPORARY.
SELECT IF (BUYIND EQ 0).
/*** RUN DSECRIPTIVE STATISTICS ON THE FILE ***/
SET WIDTH=132.

DESCRIPTIVES

VARIABLES=paccnum TO m000bcii

/STATISTICS=MEAN SUM STDDEV VARIANCE MIN MAX SEMEAN .

SET WIDTH=80.
/*** SEND THE FILE INTO XLS FORMAT ***/
SCRIPT “C:\addapp\statistics\spssScripts\LAST Xport_to_Excel_(BIFF).SBS”
/(“C:\WORKAREA\DBI\R&D\Nits-BB\VarReduc\MEANSA0.xls”).
/*** Use only the data for the buyers. BUYIND = 1 ***/
TEMPORARY.
SELECT IF (BUYIND EQ 1).
/*** RUN DSECRIPTIVE STATISTICS ON THE FILE ***/
SET WIDTH=132.

DESCRIPTIVES

VARIABLES=paccnum TO m000bcii

/STATISTICS=MEAN SUM STDDEV VARIANCE MIN MAX SEMEAN .

SET WIDTH=80.
/*** SEND THE FILE INTO XLS FORMAT ***/
SCRIPT “C:\addapp\statistics\spssScripts\LAST Xport_to_Excel_(BIFF).SBS”
/(“C:\WORKAREA\DBI\R&D\Nits-BB\VarReduc\MEANSA1.xls”).
/*** READ THE XLS FILE INTO SPSS SPECIFIED RANGES ***/
GET DATA /TYPE=XLS

/FILE=‘C:\WORKAREA\DBI\R&D\Nits-BB\VarReduc\MEANSA0.xls’
/SHEET=name ‘Sheet1’
/CELLRANGE=range ‘A3:I995’
/READNAMES=on.

/*** RENAME THE VARIABLES ***/
RENAME VARIABLES (STATISTI=N_0).
RENAME VARIABLES (V3=MINIM_0).
RENAME VARIABLES (V4=MAXIM_0).
RENAME VARIABLES (V5=SUM_0).
RENAME VARIABLES (V6=MEAN_0).
RENAME VARIABLES (V8=STDEV_0).
RENAME VARIABLES (V9=VARNC_0).
RENAME VARIABLES (std._err=STD_ER_0).
/*** SEPARATE THE VAR NAME AND THE VAR DESCRIPTION ***/
/*** REMEMBER TO CHANGE THE MAX COMPUTE N_PCNT_0 =
(N_0/20000)*100 ***/
STRING VARNAME(A8).
STRING VARDISC(A60).
COMPUTE VARNAME=SUBSTR(V1,1,8).
COMPUTE VARDISC=SUBSTR(V1,9).
COMPUTE N_PCNT_0 = (N_0/20000)*100.
FORMAT N_PCNT_0(PCT5.2).
EXECUTE.
SORT CASES BY VARNAME.
SAVE OUTFILE=‘C:\WORKAREA\DBI\R&D\Nits-BB\VarReduc\MEANSA0.sav’

/KEEP=varname n_0 n_pcnt_0 maxim_0 minim_0 mean_0 sum_0 stdev_0 varnc_0

std_er_0 vardisc /COMPRESSED.
NEW FILE.
/*** READ THE XLS FILE INTO SPSS SPECIFIED RANGES ***/
GET DATA /TYPE=XLS

/FILE=‘C:\WORKAREA\DBI\R&D\Nits-BB\VarReduc\MEANSA1.xls’
/SHEET=name ‘Sheet1’
/CELLRANGE=range ‘A3:I995’
/READNAMES=on.

/*** RENAME THE VARIABLES ****/
RENAME VARIABLES (STATISTI=N_1).
RENAME VARIABLES (V3=MINIM_1).
RENAME VARIABLES (V4=MAXIM_1).
RENAME VARIABLES (V5=SUM_1).
RENAME VARIABLES (V6=MEAN_1).
RENAME VARIABLES (V8=STDEV_1).
RENAME VARIABLES (V9=VARNC_1).
RENAME VARIABLES (std._err=STD_ER_1).
/*** SEPARATE THE VAR NAME AND THE VAR DESCRIPTION ***/
/*** REMEMBER TO CHANGE THE MAX COMPUTE N_PCNT_1=(N_1/20000)*100
***/
STRING VARNAME(A8).
STRING VARDISC(A60).
COMPUTE VARNAME=SUBSTR(V1,1,8).
COMPUTE VARDISC=SUBSTR(V1,9).
COMPUTE N_PCNT_1 = (N_1/20000)*100.
FORMAT N_PCNT_1(PCT5.2).
EXECUTE.
SORT CASES BY VARNAME.
SAVE OUTFILE=‘C:\WORKAREA\DBI\R&D\Nits-BB\VarReduc\MEANSA1.sav’

/KEEP=varname n_1 n_pcnt_1 maxim_1 minim_1 mean_1 sum_1 stdev_1 varnc_1

std_er_1 vardisc /COMPRESSED.
/*** Merge the files created for the 0's and 1's to check for max spread ***/
GET

FILE=‘C:\WORKAREA\DBI\R&D\Nits-BB\VarReduc\MEANSA0.sav’.

MATCH FILES /FILE=*

/FILE=‘C:\workarea\DBI\R&D\Nits-BB\VarReduc\MEANSA1.sav’
/RENAME (vardisc = d0)
/BY varname
/DROP= d0.

EXECUTE.
/*** Create the components for the t-test using BUYIND as the IV ***/
COMPUTE SUM0X2 = n_0*varnc_0 + mean_0*sum_0.
COMPUTE SUM1X2 = n_1*varnc_1 + mean_1*sum_1.
COMPUTE SUMSQRE0 = SUM0X2-((sum_0*sum_0)/n_0).
COMPUTE SUMSQRE1 = SUM1X2-((sum_1*sum_1)/n_1).
COMPUTE DF0 = N_0-1.
COMPUTE DF1 = N_1-1.
COMPUTE SP2 = ((SUMSQRE0+SUMSQRE1)/(DF0+DF1)).
COMPUTE SX0X1 = SQRT((SP2/N_0)+(SP2/N_1)).
COMPUTE T_TEST= ((mean_0-mean_1)/SX0X1).
/*** Create the t-test & the absolute the t-test (for data reduction) ***/
COMPUTE ABS_T = ABS(T_TEST).
SORT CASES BY ABS_T(D).
EXECUTE.
/*** Save the file with the data reduction indicators ***/
SAVE OUTFILE=‘C:\workarea\DBI\R&D\Nits-BB\VarReduc\MEANSA01.sav’

/COMPRESSED.

GET

FILE=‘C:\WORKAREA\DBI\R&D\Nits-BB\VarReduc\MEANSA01.sav’.

SORT CASES BY varname (A) .
/*** Add the correlation and absolute Correlation values ***/
MATCH FILES /FILE=*

/FILE=‘C:\workarea\DBI\R&D\Nits-BB\VarReduc\CORR_all.sav’
/BY varname.

EXECUTE.
COMPUTE ABSRZ=ABS(rzbuyind).
EXECUTE.
SAVE OUTFILE=‘C:\workarea\DBI\R&D\Nits-BB\VarReduc\MEANSA01.sav’

/COMPRESSED.

GET

FILE=‘C:\WORKAREA\DBI\R&D\Nits-BB\VarReduc\MEANSA01.sav’.

/*** Flag outliers by ratio of min/max to mean for both 0's & 1's ***/
COMPUTE DIFn = n_0-n_1.
COMPUTE MEAN2MX0= maxim_0/mean_0.
COMPUTE MEAN2MX1= maxim_1/mean_1.
COMPUTE MEAN2MN0= minim_0/mean_0.
COMPUTE MEAN2MN1= minim_1/mean_1.
EXECUTE.
/*** Rank the absolute t and correlation scores ***/
RANK VARIABLES= ABS_T ABSRZ /NTILES(20) INTO RABS_T RABSRZ.
/*** Flag undesired variables take top rank for t and corr scores ***/
COMPUTE FLGDROP1 = 0.
COMPUTE FLGDROP2 = 0.
COMPUTE FLGDROP3 = 0.
COMPUTE FLGDROP4 = 0.
COMPUTE FLGDROP5 = 0.
COMPUTE FLGDROP6 = 0.
COMPUTE FLGDROP7 = 0.
COMPUTE FLGDROP8 = 0.
COMPUTE FLGDROP9 = 0.
COMPUTE FLGDRP10 = 0.
COMPUTE FLGDRP11 = 0. /*** Leakers ****/
DO IF ((stdev_0 EQ 0) OR (stdev_1 EQ 0) OR SYSMIS(stdev_0 EQ 0) OR
SYSMIS(stdev_1 EQ 0)).

COMPUTE FLAGDROP1 = 10.

ELSE IF ((n_pcnt_0 LT 3.5) OR (n_pcnt_1 LT 3.5)).

COMPUTE FLGDROP2 = 9.

ELSE IF ((RABS_T LT 15)).

COMPUTE FLGDROP3 = 8.

ELSE IF ((RABSRZ LT 10)).

COMPUTE FLGDROP4 = 7.

ELSE IF ((RBUYIND GT 0.90)).

COMPUTE FLGDRP11 = 11.

ELSE IF ((MEAN2MX0 GE 50)).

COMPUTE FLGDROP5 = 6.

ELSE IF ((MEAN2MX1 GE 50)).

COMPUTE FLGDROP6 = 5.

ELSE IF ((MEAN2MN0 GE 50)).

COMPUTE FLGDROP7 = 4.

ELSE IF ((MEAN2MN1 GE 50)).

COMPUTE FLGDROP8 = 3.

ELSE IF ((SUBSTR(VARNAME,1,8) = ‘SUBSGSAL’)).

COMPUTE FLGDROP9 = 2.

ELSE IF ((SUBSTR(VARNAME,1,8) = ‘SUBSPSCD’)).

COMPUTE FLGDRP10 = 1.

END IF.
EXECUTE.
COMPUTE FLAGDROP = 0.
COMPUTE FLAGDROP = SUM(FLGDROP1, FLGDROP2, FLGDROP3, FLGDROP4,
FLGDROP5,

FLGDROP6, FLGDROP7, FLGDROP8, FLGDROP9, FLGDRP10,

FLGDRP11).
/*** Create a pivot table with all the “Modelable” variables ***/
TEMPORARY.
SELECT IF (FLAGDROP EQ 0).
freq VAR=VARNAME.
/*** Create an XLS file with the Paired Down Variables ***/
SCRIPT “C:\addapp\statistics\spssScripts\Last Xport_to_Excel_(BIFF).SBS”
/(“C:\WORKAREA\DBI\R&D\Nits-BB\VarReduc\LSTFNVAR.xls”).
/*** Read the LSTFNVAR.XLS file into SPSS SPECIFIED RANGES ***/
GET DATA /TYPE=XLS

/FILE=‘C:\workarea\DBI\R&D\Nits-BB\VarReduc\LSTFNVAR.xls’
/SHEET=name ‘Sheet1’
/CELLRANGE=range ‘B2:F229’
/READNAMES=on.

/*** Create an SAV file with one variable V1 that contain the varlist ***/
STRING V4 (A50).
COMPUTE V4=V1.
CACHE.
EXECUTE.
COMPUTE V4=V1.
CACHE.
EXECUTE.
SAVE OUTFILE=‘C:\workarea\DBI\R&D\Nits-BB\VarReduc\VARLIST.sav’

/KEEP=v1 /COMPRESSED.

RENAME VARIABLES (V1=GONE) (V4=V1).
EXECUTE.
SAVE OUTFILE=‘C:\workarea\DBI\R&D\Nits-BB\VarReduc\VARLIST.sav’

/KEEP=v1 /COMPRESSED.

GET

FILE=‘C:\workarea\DBI\R&D\Nits-BB\VarReduc\VARLIST.sav’.

/*** Create an ASCII file with the Regression Syntax ***/
DO IF ($CASENUM EQ 1).

WRITE OUTFILE=‘C:\workarea\DBI\R&D\Nits-BB\VarReduc\reg1.dat’

/‘REGRESSION’
/‘/MISSING LISTWISE’
/‘/STATISTICS COEFF OUTS R ANOVA COLLIN TOL’
/‘/CRITERIA=PIN(.00000000005) POUT(.000010)’
/‘/NOORIGIN’
/‘/DEPENDENT BUYIND’
/‘/METHOD=STEPWISE’.

END IF.
EXECUTE.
/*** Read the ASCII file into SPSS.SAV file ***/
GET DATA /TYPE = TXT

/FILE = ‘C:\workarea\DBI\R&D\Nits-BB\VarReduc\reg1.dat’
/FIXCASE = 1
/ARRANGEMENT = FIXED
/FIRSTCASE = 1
/IMPORTCASE = ALL
/VARIABLES =
/1 V1 0-49 A50
V2 50-50 A1.

CACHE.
EXECUTE.
/*** Save the ASCII file into SPSS.SAV file ***/
SAVE OUTFILE=‘C:\workarea\DBI\R&D\Nits-BB\VarReduc\reg1.sav’

/KEEP=v1 /COMPRESSED.

/*** Create an ASCII file with one record a‘.’ ***/
/*** The DO IF ($CASENUM EQ 1). cause the output to happen only once ***/
DO IF ($CASENUM EQ 1).

WRITE OUTFILE=‘C:\workarea\DBI\R&D\Nits-BB\VarReduc\dot.dat’
/‘.’.

END IF.
EXECUTE.
/*** Create an ASCII file with one record a‘.’ ***/
GET DATA /TYPE = TXT
/FILE = ‘C:\workarea\DBI\R&D\Nits-BB\VarReduc\dot.dat’
/FIXCASE = 1
/ARRANGEMENT = FIXED
/FIRSTCASE = 1
/IMPORTCASE = ALL
/VARIABLES =
/1 V1 0-49 A50 V2 50-50 A1.
CACHE.
EXECUTE.
SAVE OUTFILE=‘C:\workarea\DBI\R&D\Nits-BB\VarReduc\dot.sav’

/KEEP=v1 /COMPRESSED.

GET

FILE=‘C:\workarea\DBI\R&D\Nits-BB\VarReduc\reg1.sav’.

ADD FILES /FILE=*

/FILE=‘C:\workarea\DBI\R&D\Nits-BB\VarReduc\VARLIST.sav’.

ADD FILES /FILE=*

/FILE=‘C:\workarea\DBI\R&D\Nits-BB\VarReduc\dot.sav’.

EXECUTE.
SAVE OUTFILE=‘C:\workarea\DBI\R&D\Nits-BB\VarReduc\regout.sav’

/COMPRESSED.

/*** All the regression syntax lines other than the KEYWORD ***/
/*** REGRESSION should be indented at least one space. The ***/
/*** LPAD doesn't work as it should this is why the “rtrim” ***/
DO IF (SUBSTR(V1,1,1)=‘/’).

compute v1=lpad(rtrim(v1),50).
COMPUTE Z=12.

ELSE IF ((SUBSTR(V1,1,3)<> ‘REG’) AND (SUBSTR(V1,1,1)<>‘/’)).

compute v1=lpad(rtrim(v1),20)

END IF.
WRITE OUTFILE=‘C:\workarea\DBI\R&D\Nits-BB\VarReduc\regout.SPS’

/V1.

EXECUTE.
/*** Get the original file for the “final” regression run ***/
GET

FILE=‘C:\workarea\DBI\R&D\Nits-BB\regtest614.sav’.

INCLUDE FILE=‘C:\workarea\DBI\R&D\Nits-BB\VarReduc\regout.SPS’.

While the invention has been particularly shown and described with reference to preferred embodiments thereof, it will be understood by those skilled in the art that various other changes in the form and details may be made therein without departing from the spirit and scope of the invention.

What is claimed is:

1. A computer-implemented method for creating a prediction model, comprising:
accessing from storage media representative data for a plurality of independent variables relevant to the prediction model to be created;
processing the representative data to eliminate one or more of the plurality of independent variables and to infer data where an instance of representative data for an independent variable is missing; and
generating a prediction model based on the independent variables that were not eliminated, the representative data input to the computer, and the inferred data.

2. The method of claim 1, wherein data for a missing value is inferred by implementing an inference model.

3. The method of claim 1, wherein the one or more independent variables are eliminated because of faulty statistical qualities.

4. The method of claim 1 further comprising sampling the representative data before it is processed.

5. A computer-implemented method for creating a prediction model, comprising:
sampling representative data for a plurality of independent variables relevant to the prediction model to be created to reduce the amount of data to process;
processing the sampled representative data to eliminate one or more of the plurality of independent variables;
generating a prediction model based on the independent variables that were not eliminated and the sampled representative data input to the computer.

6. The method of claim 5, wherein sampling the representative data involves stratified sampling.

7. The method of claim 5, wherein the one or more independent variables are eliminated by detecting independent variables that are highly correlative.

8. The method of claim 5, wherein processing the representative data further includes inferring one or more missing values for the independent variables.

9. A computer-implemented method for creating a prediction model, comprising:
sampling representative data for a plurality of independent variables relevant to the prediction model to be created to reduce the amount of data to process;
processing the sampled representative data to infer data where an instance of representative data for an independent variable is missing; and
generating a prediction model based on the independent variables, the sampled representative data input to the computer, and the inferred data.

10. The method of claim 9, wherein sampling the representative data involves bootstrap sampling.

11. The method of claim 9, wherein the data is inferred by computing the mean for the independent variable corresponding to the missing value and substituting the mean for the missing value.

12. The method of claim 9, wherein processing the representative data further includes eliminating one or more of the plurality of independent variables.

13. A computer-implemented method for evaluating a prediction model in view of an alternate prediction model, comprising:
accessing from storage media representative data for a plurality of independent variables relevant to the prediction model to be evaluated;
processing the prediction model based at least on one or more of the independent variables and the representative data to produce a power of segmentation curve;
processing the alternate prediction model based on at least one or more of the independent variables and the representative data to produce an alternate power of segmentation curve;
computing the area under the power of segmentation curve and the area under the alternate power of segmentation curve; and
comparing the area under the power of segmentation curve to the area under the alternate power of segmentation curve to evaluate the prediction model.

14. The method of claim 13, further comprising sampling the representative data before beginning processing.

15. The method of claim 13, wherein the processing comprises inferring values for data that is missing for one or more of the plurality of independent variables.

16. The method of claim 13, wherein the processing comprises eliminating one or more of the plurality of independent variables.

17. A computer-implemented method for creating a prediction model for a dichotomous event, comprising:
accessing from storage media representative data for a plurality of independent variables relevant to the prediction model to be created;
dividing the representative data into a first and a second group, the first group including the representative data taken for an occurrence of a first dichotomous state, and the second group including the representative data taken for an occurrence of a second dichotomous state;
computing statistical characteristics of the representative data for the first group and the second group;
detecting independent variables having unreliable statistical characteristics from either the first group, the second group, or from both the first and second groups;
eliminating the independent variables detected as having unreliable statistical characteristics; and
generating a prediction model based on the independent variables that were not eliminated and the representative data input to the computer.

18. The method of claim 17, wherein the unreliable statistical characteristics include poor variable coverage.

19. The method of claim 18, further comprising processing the representative data to infer missing data where an instance of representative data for an independent variable is missing.

20. The method of claim 17, wherein the unreliable statistical characteristics include a relatively small standard deviation.

21. The method of claim 17, wherein the representative data is sampled before it is divided.

22. A computer-implemented method for training prediction modeling analysts, comprising:
displaying components of an operational flow of a prediction model creation process on a display screen;
receiving a selection from a user of one or more components from the operational flow being displayed;
accessing a result of the operation of the one or more selected components and displaying the result.

23. The method of claim 22, further comprising employing the one or more selected components on underlying modeling data and variables to compute the result.

24. The method of claim 22, wherein the steps are implemented by a web browser.

25. A computer-implemented method for creating a prediction model, comprising:
accessing from storage media representative data for a plurality of independent variables relevant to the prediction model to be created;
receiving one or more modeling switch selections to configure a modeling process used when creating the model from the plurality of independent variables and representative data; and
processing the representative data and the plurality of independent variables according to the received modeling switch selections to generate a prediction model based on the independent variables and the representative data.

26. The method of claim 25, further comprising sampling the representative data before processing.

27. The method of claim 25, wherein processing the representative data further includes inferring data where an instance of representative data for an independent variable is missing.

28. The method of claim 27, wherein the modeling switch selections include one or more threshold values used to select an operation for inferring for the instance of missing data.

29. The method of claim 25, wherein processing the representative data further includes eliminating one or more of the plurality of independent variables.

30. The method of claim 29, wherein the modeling switch selections include one or more threshold values used to select the one or more independent variables to eliminate.

31. An apparatus for creating a prediction model, comprising:
storage media containing representative data for a plurality of independent variables relevant to the prediction model to be created;
a processor configured to access the representative data and eliminate one or more of the plurality of independent variables, infer data where an instance of representative data for an independent variable is missing, and generate a prediction model based on the independent variables that were not eliminated, the representative data input to the computer, and the inferred data.

32. The apparatus of claim 31, wherein the processor is further configured to infer data for a missing value by implementing an inference model.

33. The apparatus of claim 31, wherein the processor is configured to eliminate one or more independent variables because of faulty statistical qualities.

34. The apparatus of claim 31, wherein the processor is further configured to sample the representative data before it is processed.

35. An apparatus for creating a prediction model, comprising:
storage media containing representative data for a plurality of independent variables relevant to the prediction model to be created;
a processor configured to sample representative data for a plurality of independent variables relevant to the prediction model to be created to reduce the amount of data to process, eliminate one or more of the plurality of independent variables, and generate a prediction model based on the independent variables that were not eliminated and the sampled representative data input to the computer.

36. The apparatus of claim 35, wherein the processor is configured to sample the representative data using stratified sampling.

37. The apparatus of claim 35, wherein the processor is configured to eliminate one or more independent variables by detecting independent variables that are highly correlative.

38. The apparatus of claim 35, wherein the processor is further configured to infer one or more missing values for the independent variables.

39. An apparatus for creating a prediction model, comprising:
storage media containing representative data for a plurality of independent variables relevant to the prediction model to be created;
a processor configured to sample representative data for a plurality of independent variables relevant to the prediction model to be created to reduce the amount of data to process, infer data where an instance of representative data for an independent variable is missing, and generate a prediction model based on the independent variables, the sampled representative data input to the computer, and the inferred data.

40. The apparatus of claim 39, wherein the processor is further configured to sample the representative data by bootstrap sampling.

41. The apparatus of claim 39, wherein the processor is further configured to infer data by computing the mean for the independent variable corresponding to the missing value and substituting the mean for the missing value.

42. The apparatus of claim 39, wherein the processor is further configured to eliminate one or more of the plurality of independent variables.

43. An apparatus for evaluating a prediction model in view of an alternate prediction model, comprising:
storage media containing representative data for a plurality of independent variables relevant to the prediction model to be evaluated;
a processor configured to generate the prediction model based at least on one or more of the independent variables and the representative data to produce a power of segmentation curve, generate an alternate prediction model based on at least one or more of the independent variables and the representative data to produce an alternate power of segmentation curve, compute the area under the power of segmentation curve and the area under the alternate power of segmentation curve, and compare the area under the power of segmentation curve to the area under the alternate power of segmentation curve to evaluate the prediction model.

44. The apparatus of claim 43, wherein the processor is further configured to sample the representative data before beginning processing.

45. The apparatus of claim 43, wherein the processor is further configured to infer values for data that is missing for one or more of the plurality of independent variables.

46. The apparatus of claim 43, wherein the processor is further configured to eliminate one or more of the plurality of independent variables.

47. An apparatus for creating a prediction model for a dichotomous event, comprising:
storage media containing representative data for a plurality of independent variables relevant to the prediction model to be created;
a processor configured to divide the representative data into a first and a second group, the first group including the representative data taken for an occurrence of a first dichotomous state, and the second group including the representative data taken for an occurrence of a second dichotomous state, compute statistical characteristics of the representative data for the first group and the second group, detect independent variables having unreliable statistical characteristics from either the first group, the second group, or from both the first and second groups, eliminate the independent variables detected as having unreliable statistical characteristics, and generate a prediction model based on the independent variables that were not eliminated and the representative data input to the computer.

48. The apparatus of claim 47, wherein the unreliable statistical characteristics include poor variable coverage.

49. The apparatus of claim 48, wherein the processor is further configured to infer missing data where an instance of representative data for an independent variable is missing.

50. The apparatus of claim 47, wherein the unreliable statistical characteristics include a relatively small standard deviation.

51. The apparatus of claim 47, wherein the processor is further configured to sample the representative data it is divided.

52. An apparatus for training prediction modeling analysts, comprising:
a display screen configured to display components illustrating the operational flow of the prediction model creation process;
an input device that receives a selection from a user of one or more components from the operational flow being displayed;
a processor configured to access results from operation of the one or more selected components and deliver the results to the display screen.

53. The apparatus of claim 52, wherein the processor is further configured to employ the one or more selected components on underlying modeling data and variables to compute the result.

54. The apparatus of claim 52, wherein the processor is further configured to implement a web browser that controls the display of the components, the reception of the selection, and the accessing of results.

55. An apparatus for creating a prediction model, comprising:
storage media containing representative data for a plurality of independent variables relevant to the prediction model to be created;
an input device that receives one or more modeling switch selections to configure a modeling process used when creating the model from the plurality of independent variables and representative data; and
a processor configured to generate a prediction model according to the receivedmodeling switch selections based on the independent variables and the representative data.

56. The apparatus of claim 55, wherein the processor is further configured to sample the representative data before processing.

57. The apparatus of claim 55, wherein the processor is further configured to infer data where an instance of representative data for an independent variable is missing.

58. The apparatus of claim 57, wherein the modeling switch selections include one or more threshold values used to select an operation for inferring for the instance of missing data.

59. The apparatus of claim 55, wherein the processor is further configured to eliminate one or more of the plurality of independent variables.

60. The apparatus of claim 59, wherein the modeling switch selections include one or more threshold values used to select the one or more independent variables to eliminate.
